(19) United States
(12) Patent Application Publication
(10) Pub. No.: US 2026/0039210 A1
(43) Pub. Date: Feb. 5, 2026

(54) POWER CONVERSION CIRCUIT AND CONTROL METHOD THEREOF THAT SWITCHES BETWEEN PULSE-WIDTH MODULATION MODE AND PULSE-FREQUENCY MODULATION MODE

(71) Applicant: Richtek Technology Corporation, Zhubei City (TW)

(72) Inventors: Kuo-Chi LIU, Hsinchu City (TW); Ta-Yung YANG, Taoyuan City (TW)

(21) Appl. No.: 19/270,810

(22) Filed: Jul. 16, 2025

Related U.S. Application Data
(60) Provisional application No. 63/679,338, filed on Aug. 5, 2024.

(30) Foreign Application Priority Data
Mar. 6, 2025 (TW) 114108224

(51) Int. Cl. H02M 3/335; H02M 1/00; H02M 3/00

(52) U.S. Cl. CPC H02M 3/33569; H02M 1/0009; H02M 1/0058; H02M 3/01

(57) ABSTRACT

A power conversion circuit includes a transformer, a resonant capacitor, a resonant inductor, a high-side transistor, a low-side transistor, and a control circuit. The transformer includes a primary coil and a secondary coil. The primary coil, the resonant capacitor, and the resonant inductor are connected in series between a switch node and a ground. The high-side transistor provides an input voltage to a switch node based on the high-side driving signal. The low-side transistor couples the switch node to the ground based on the low-side transistor. The control circuit operates in a pulse frequency modulation mode to generate the high-side transistor and the low-side transistor with a switch frequency. When the switch frequency exceeds the first threshold, the control circuit switches from the pulse frequency modulation mode to the pulse width modulation mode.

### CROSS REFERENCE TO RELATED APPLICATIONS

This application claims the benefit of U.S. Provisional Application No. 63/679,338, filed on Aug. 5, 2024, the entirety of which is incorporated by reference herein.

This Application claims priority of Taiwan Patent Application No. 114108224, filed on Mar. 6, 2025, the entirety of which is incorporated by reference herein.

### BACKGROUND OF THE INVENTION

### Field of the Invention

The disclosure is generally related to a power conversion circuit and a control method thereof, and more particularly it is related to a power conversion circuit and a control method thereof that switches between a pulse-width modulation mode and a pulse-frequency modulation mode.

### Description of the Related Art

With the continuous development of portable electronic devices, the developmental trend in the field of power conversion circuits is, as with most power products, moving towards high efficiency, high power density, high reliability, and low cost. Since resonant power conversion circuits (including LLC resonant power conversion circuits, etc.) have the advantages of achieving zero-voltage switching (ZVS) on the primary side and zero-current switching (ZCS) of the rectification diode on the secondary side within the full load range. Further advantages include using frequency control to make sure that the duty cycles of the high-side transistor and the low-side transistor are both 50%; ensuring that no output inductor is required; and adapting lower voltage transistors on the secondary side to reduce costs and improve efficiency. As a result, they have increasingly been used in DC voltage converters in recent years.

However, due to the characteristics of the resonant power conversion circuit, a higher switching frequency must be used when the output voltage is low or the load is light, resulting in a poor conversion efficiency of the resonant power conversion circuit. In order to meet the current market demand for a wide range of output voltages, high output power, and high conversion efficiency, it is necessary to further optimize the power conversion circuit to meet market demand.

### BRIEF SUMMARY OF THE INVENTION

The present invention proposes a power conversion circuit and a control method thereof that switch between a pulse frequency modulation mode and a pulse width modulation mode, so as to achieve the requirements of a wide range of output voltages, high output power, and high conversion efficiency at the same time. Since the power conversion circuit operating in the pulse frequency modulation mode is beneficial to provide better conversion efficiency under high output power conditions, and the power conversion circuit operating in the pulse width modulation mode is beneficial to provide better conversion efficiency under low output power conditions, operating the power conversion circuit in the corresponding mode under different output power conditions is beneficial to improve the overall conversion efficiency of the wide range of output voltages.

In an embodiment, a power conversion circuit comprises a transformer, a resonant capacitor, a resonant inductor, a high-side transistor, a low-side transistor, and a control circuit. The transformer comprises a primary coil and a secondary coil. The primary coil, the resonant capacitor, and the resonant inductor are coupled in series between a switch node and a ground. The high-side transistor provides an input voltage to the switch node based on a high-side driving signal. The low-side transistor couples the switch node to the ground based on a low-side driving signal. The control circuit operates in a pulse frequency modulation mode to generate the high-side driving signal and the low-side driving signal with a switching frequency. When the switching frequency exceeds a first threshold, the control circuit switches from the pulse frequency modulation mode to a pulse width modulation mode.

According to an embodiment of the present invention, the resonant capacitor and the resonant inductor determine a resonant frequency. The first threshold exceeds the resonant frequency.

According to an embodiment of the present invention, the resonant inductor is generated by a leakage inductance of the primary coil.

According to an embodiment of the present invention, when the control circuit operates in the pulse frequency modulation mode, the switch frequency is related to the output voltage. When the control circuit operates in the pulse width modulation mode, an on-time of the low-side transistor is related to the output voltage.

According to an embodiment of the present invention, when the control circuit operates in the pulse width modulation mode and an output power exceeds a second threshold, the control circuit switches to the pulse frequency modulation mode.

According to an embodiment of the present invention, the power conversion circuit further comprises a rectification circuit, a detection circuit, and a feedback circuit. The rectification circuit converts energy of the secondary coil to the output power of an output voltage. The detection circuit is coupled to the resonant node to generate a current detection signal. The feedback circuit generates a compensation signal based on a difference between the output voltage and a reference voltage.

According to an embodiment of the present invention, the control circuit generates the high-side driving signal and the low-side driving signal based on the current detection signal and the output power of the output voltage. The compensation signal is related to the output power. When the compensation signal exceeds a third threshold, the control circuit operates in the pulse frequency modulation mode.

According to an embodiment of the present invention, the control circuit further comprises a mode control circuit. The mode control circuit is configured to determine a mode signal based on the switch frequency and the compensation signal. The control circuit operates in either the pulse frequency modulation mode or the pulse width modulation mode based on the mode signal.

According to an embodiment of the present invention, the mode control circuit further comprises a first comparator and a second comparator. The first comparator compares the compensation signal with the third threshold to generate a first comparison signal. The second comparator compares the switching frequency with the first threshold to generate a second comparison signal. When the compensation signal exceeds the third threshold, the first comparator enables the first comparison signal. When the switching frequency exceeds the first threshold, the second comparator enables the second comparison signal.

According to an embodiment of the present invention, the mode control circuit enables the mode signal based on the first comparison signal being enabled. The mode control circuit disables the mode signal based on the second comparison signal being enabled. When the mode signal is enabled, the control circuit operates in the pulse frequency modulation mode. When the mode signal is disabled, the control circuit operates in the pulse width modulation mode.

According to an embodiment of the present invention, the mode signal is enabled or disabled during both the high-side transistor and the low-side transistor being turned off.

According to an embodiment of the present invention, the control circuit further comprises a first control circuit. The first control circuit generates the high-side driving signal and the low-side driving signal based on the current detection signal and the compensation signal. When the control circuit operates in the pulse frequency modulation mode, the control circuit drives the high-side transistor and the low-side transistor using the high-side driving signal and the low-side driving signal generated by the first control circuit respectively.

According to an embodiment of the present invention, the first control circuit further comprises a first transconductance amplifier, a second transconductance amplifier, a third comparator, and a fourth comparator. The first transconductance amplifier generates a first amplified signal based on the current detection signal. The second transconductance amplifier generates a second amplified signal based on the current detection signal. The first amplified signal and the second amplified signal have different phases. When the first amplified signal exceeds the compensation signal, the third comparator enables a third comparison signal. When the second amplified signal exceeds the compensation signal, the fourth comparator enables a fourth comparison signal. The first control circuit disables the high-side driving signal based on the third comparison being enabled and enables the low-side driving signal after a first dead time. The first control circuit disables the low-side driving signal based on the fourth comparison signal being enabled and enables the high-side driving signal after a second dead time.

According to an embodiment of the present invention, the control circuit further comprises a second control circuit. The second control circuit generates the high-side driving signal and the low-side driving signal based on the current detection signal and the compensation signal. When the control circuit operates in the pulse width modulation mode, the control circuit drives the high-side transistor and the low-side transistor using the high-side driving signal and the low-side driving signal from the second control circuit, respectively.

According to an embodiment of the present invention, the second control circuit further comprises a third transconductance amplifier, a fifth comparator, and an on-time control circuit. The third transconductance amplifier generates a third amplified signal based on the current detection signal. When the third amplified signal exceeds the compensation signal, the fifth comparator enables a fifth comparison signal. The on-time control circuit adjusts an on-time of the low-side driving signal. The second control circuit disables the high-side driving signal based on the fifth comparison signal being enabled. The on-time control circuit enables the low-side driving signal after the high-side driving signal is disabled and a third dead time has been delayed. The second control circuit enables the high-side driving signal after the low-side driving signal is disabled and a fourth dead time has been delayed.

In another embodiment, a control method for controlling a power conversion circuit is provided. The control method comprises the following steps. A pulse frequency modulation mode is operated to drive a first transistor and a second transistor on a primary side of the power conversion circuit with a switching frequency and to generate an output voltage on a secondary side of the power conversion circuit. It is determined whether the switching frequency exceeds a first threshold. When the switching frequency does not exceed the first threshold, it is operated the pulse frequency modulation mode. When the switching frequency exceeds the first threshold, it is switched from the pulse frequency modulation mode to a pulse width modulation mode.

According to an embodiment of the present invention, the primary side comprises a resonant capacitor and a resonant inductor coupled in series. The resonant capacitor and the resonant inductor determine a resonant frequency. The first threshold exceeds the resonant frequency.

According to an embodiment of the present invention, in the pulse frequency modulation mode, the output voltage is related to the switching frequency.

According to an embodiment of the present invention, the control method further comprises the following steps. Output power of the output voltage is detected. When operating in the pulse width modulation mode, it is determined whether the output power exceeds a second threshold. When the output power does not exceed the second threshold, it is operated in the pulse width modulation mode. When the output power exceeds the second threshold, it is switched the pulse width modulation mode to the pulse frequency modulation mode.

According to an embodiment of the present invention, when operating in the pulse frequency modulation mode, an on-time of the high-side transistor is equal to an on-time of the low-side transistor.

According to an embodiment of the present invention, when operating in the pulse width modulation mode, each switching period comprises a plurality of periods. The first transistor is turned on and the second transistor is turned off in a first driving period. After the first driving period, the first transistor and the second transistor are simultaneously turned off in a first reset period. After the first rest period, the first transistor is turned off and the second transistor is turned on in a second driving period. After the second driving period, the first transistor and the second transistor are simultaneously turned off in a second rest period. After the second rest period, the first transistor is turned on and the second transistor is turned off in a third driving period. After the third driving period, the first transistor and the second transistor are simultaneously turned off in a third rest period. After the third rest period, the first transistor is turned off and the second transistor is turned on in a fourth driving period. After the fourth driving period, the first transistor and the second transistor are simultaneously turning off in a fourth rest period.

According to an embodiment of the present invention, the control method further comprises the following steps. After the fourth rest period of a first switching period, the first driving period of a second switching period is begun. When the first transistor is turned on during the first driving period of the second switching period, the first transistor is turned on under valley switching.

According to an embodiment of the present invention, a length of the first driving period is related to an output voltage of the power conversion circuit.

According to an embodiment of the present invention, the control method further comprises the following steps. A length of the first rest period is adjusted to reduce a voltage across the second transistor when the second transistor is turned on during the second driving period.

According to an embodiment of the present invention, a length of the second driving period is related to whether the first transistor achieves zero-voltage switching during the third driving period.

According to an embodiment of the present invention, the control method further comprises the following steps. A length of the second driving period and a length of the second rest period are adjusted to reduce a voltage across the first transistor when the first transistor is turned on during the third driving period.

According to an embodiment of the present invention, a length of the third driving period is related to the output voltage.

According to an embodiment of the present invention, the control method further comprises the following steps. A length of the third rest period is adjusted to reduce a voltage across the second transistor when the second transistor is turned on during the fourth driving period.

According to an embodiment of the present invention, the first transistor achieves zero-voltage switching when the first transistor is turned on during the third driving period. The first transistor achieves valley switching when the first transistor is turned on during the first driving period.

According to an embodiment of the present invention, the second transistor achieves zero-voltage switching during the second driving period and the fourth driving period.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a schematic diagram showing a power conversion circuit in accordance with an embodiment of the present invention;

FIG. 2 is a schematic diagram showing a detection circuit in accordance with an embodiment of the present invention;

FIG. 3 is a schematic diagram showing a feedback circuit in accordance with an embodiment of the present invention;

FIG. 4 is a relationship diagram showing a relationship between the voltage gain and the normalized frequency of the power conversion circuit operating in the pulse frequency modulation mode in accordance with an embodiment of the present invention;

FIG. 5 is a schematic diagram showing an operating mode of the power conversion circuit in accordance with an embodiment of the present invention;

FIG. 6 is a schematic diagram showing a mode control circuit in accordance with an embodiment of the present invention;

FIG. 7 shows a waveform diagram of the power conversion circuit switching between the pulse frequency modulation mode and the pulse width modulation mode in accordance with an embodiment of the present invention;

FIG. 8 is a schematic diagram showing a first control circuit in accordance with an embodiment of the present invention;

FIG. 9 is a schematic diagram showing a second control circuit in accordance with an embodiment of the present invention;

FIG. 10 shows a waveform diagram of the power conversion circuit operating in the pulse width modulation mode in accordance with an embodiment of the present invention;

FIG. 11 is a schematic diagram showing a second control circuit in accordance with another embodiment of the present invention;

FIG. 12 is a schematic diagram showing a second control circuit in accordance with another embodiment of the present invention;

FIG. 13 shows a waveform diagram of the power conversion circuit operating in the pulse width modulation mode in accordance with another embodiment of the present invention;

FIG. 14 is a schematic diagram showing a valley detection circuit in accordance with an embodiment of the present invention;

FIG. 15 is a schematic diagram showing a second control circuit in accordance with another embodiment of the present invention;

FIG. 16 is a waveform diagram showing a power conversion circuit operating in a pulse width modulation mode in accordance with another embodiment of the present invention;

FIG. 17 is a schematic diagram showing a second control circuit in accordance with another embodiment of the present invention;

FIG. 18 is a schematic diagram showing a second zero-current detection circuit in accordance with an embodiment of the present invention;

FIG. 19 is a waveform diagram of the power conversion circuit operating in the pulse width modulation mode in accordance with another embodiment of the present invention;

FIG. 20 is a waveform diagram of the power conversion circuit operating in the pulse width modulation mode in accordance with another embodiment of the present invention;

FIG. 21 is a waveform diagram of the power conversion circuit operating in the pulse width modulation mode in accordance with another embodiment of the present invention; and

FIG. 22 is a flowchart showing a control method in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

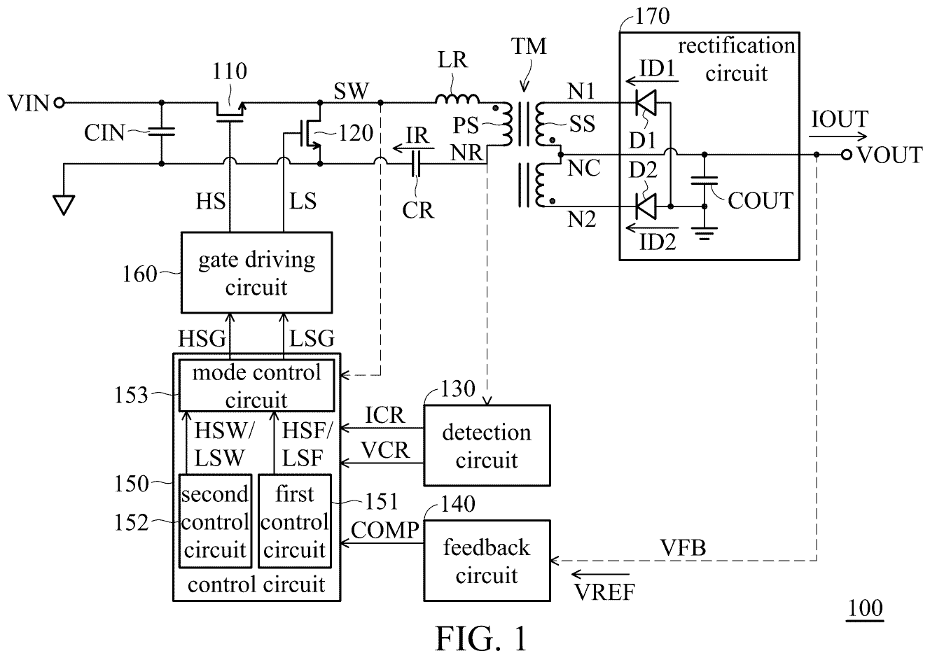

FIG. 1 is a schematic diagram showing a power conversion circuit in accordance with an embodiment of the present invention. As shown in FIG. 1, the power conversion circuit 100 is configured to convert the input voltage VIN to the output voltage VOUT, and includes a transformer TM, a resonant inductor LR, a resonant capacitor CR, an input capacitor CIN, a high-side transistor 110, a low-side transistor 120, a detection circuit 130, a feedback circuit 140, a control circuit 150, and a gate driving circuit 160.

The transformer TM includes a primary coil PS and a secondary coil SS, where the primary coil PS is coupled to the resonant node NR. The resonant inductor LR is coupled between the switch node SW and the primary coil PS, and the resonant capacitor CR is coupled to the resonant node NR and the ground. According to an embodiment of the present invention, the resonant inductance LR may be replaced by the leakage inductance of the primary coil PS of the transformer TM. In other words, the primary coil PS may be coupled between the switch node SW and the resonant node NR.

As shown in FIG. 1, the input capacitor CIN is coupled between the input voltage VIN and the ground. The high-side driving signal HS drives the high-side transistor 110 to provide the input voltage VIN to the switch node SW. The low-side driving signal LS drives the low-side transistor 120 to couple the switch node SW to the ground. According to some embodiments of the present invention, the high-side transistor 110 and the low-side transistor 120 form a half-bridge circuit to drive the primary coil PS and the resonant capacitor CR.

The detection circuit 130 is coupled to the resonant node NR to generate the current detection signal ICR and the voltage detection signal VCR. According to some embodiments of the present invention, the current detection signal ICR is configured to represent the resonant current IR flowing through the resonant capacitor CR, and the voltage detection signal VCR is configured to represent the voltage across the resonant capacitor CR. According to an embodiment of the present invention, the detection circuit 130 may include a detection resistor coupled between the resonant capacitor CR and the ground (not shown in FIG. 1), where the voltage across the detection resistor is the current detection signal ICR. According to some embodiments of the present invention, the current detection signal ICR is a voltage signal.

The feedback circuit 140 is configured to generate a compensation signal COMP based on the feedback voltage VFB and the reference voltage VREF. According to some embodiments of the present invention, the feedback voltage VFB is proportional to the output voltage VOUT. According to some embodiments of the present invention, the feedback circuit 140 may include an error amplifier, and the positive terminal of the error amplifier receives a reference voltage VREF, the negative terminal receives a feedback voltage VFB, and the feedback circuit 140 compares the output voltage VOUT with the reference voltage VREF to generate a compensation signal COMP. It is illustrated that the compensation signal COMP is generated by using the feedback voltage VFB, but not intended to be limited thereto. According to other embodiments of the present invention, the feedback circuit 140 may also compare the output voltage VOUT with the reference voltage VREF to generate a compensation signal COMP.

According to some embodiments of the present invention, the feedback circuit 140 generates a compensation signal COMP using the difference between the feedback voltage VFB and the reference voltage VREF, so that the output voltage VOUT reaches the target value and the feedback voltage VFB is equal to the reference voltage VREF. According to one embodiment of the present invention, when the feedback voltage VFB exceeds the reference voltage VREF, the feedback circuit 140 lowers the compensation signal COMP. According to another embodiment of the present invention, when the reference voltage VREF exceeds the feedback voltage VFB, the feedback circuit 140 raises the compensation signal COMP. According to an embodiment of the present invention, the feedback circuit 140 may include a voltage divider circuit for dividing the output voltage VOUT to generate the feedback voltage VFB.

The control circuit 150 operates in either the pulse frequency modulation mode or the pulse width modulation mode to generate the high-side gate driving signal HSG and the low-side gate driving signal LSG based on the voltage of the current detection signal ICR and the compensation signal COMP. According to another embodiment of the present invention, the control circuit 150 may generate a high-side gate driving signal HSG and a low-side gate driving signal LSG based on the voltage of the switch node SW, the current detection signal ICR, the voltage detection signal VCR, and the compensation signal COMP. The gate driving circuit 160 generates the high-side driving signal HS based on the high-side gate driving signal HSG, and generates the low-side driving signal LS based on the low-side gate driving signal LSG.

According to other embodiments of the present invention, since the current detection signal ICR and the voltage detection signal VCR are configured to detect the resonant current IR flowing through the resonant capacitor CR, and the compensation signal COMP is configured to represent the state of the output voltage VOUT, it can be regarded as the control circuit 150 driving the high-side transistor 110 and the low-side transistor 120 based on the output voltage VOUT and the resonant current IR.

As shown in FIG. 1, the control circuit 150 further includes a first control circuit 151, a second control circuit 152, and a mode control circuit 153. The first control circuit 151 generates a high-side frequency driving signal HSF and a low-side frequency driving signal LSF based on the current detection signal ICS and the compensation signal COMP. The second control circuit 152 generates a high-side width driving signal HSW and a low-side width driving signal LSW based on the current detection signal ICS and the compensation signal COMP.

According to one embodiment of the present invention, when the control circuit 150 operates in the pulse frequency modulation mode, the mode control circuit 153 outputs the high-side frequency driving signal HSF and the low-side frequency driving signal LSF as the high-side gate driving signal HSG and the low-side gate driving signal LSG, respectively. According to another embodiment of the present invention, when the control circuit 150 operates in the pulse width modulation mode, the mode control circuit 153 outputs the high-side width driving signal HSW and the low-side width driving signal LSW as the high-side gate driving signal HSG and the low-side gate driving signal LSG, respectively.

As shown in FIG. 1, the power conversion circuit 100 further includes a rectification circuit 170. The rectification circuit 170 includes a first rectifier element D1, a second rectifier element D2, and an output capacitor COUT. The first rectifier element D1 is coupled between the first node N1 of the secondary coil SS and the ground. The second rectifier element D2 is coupled between the second node N2 of the secondary coil SS and the ground. The output capacitor COUT is coupled between the intermediate node NC and the ground of the secondary coil SS, and the output voltage VOUT is generated at the intermediate node NC.

According to some embodiments of the present invention, the first rectification element D1 and the second rectification element D2 rectify the energy of the secondary coil SS into the first current ID1 and the second current ID2 respectively and supply them to the output capacitor COUT, thereby generating an output voltage VOUT and an output current IOUT. According to some embodiments of the present invention, the power conversion circuit 100 may be a resonant power conversion circuit. According to some embodiments of the present invention, the power conversion circuit 100 may be an LLC resonant power conversion circuit.

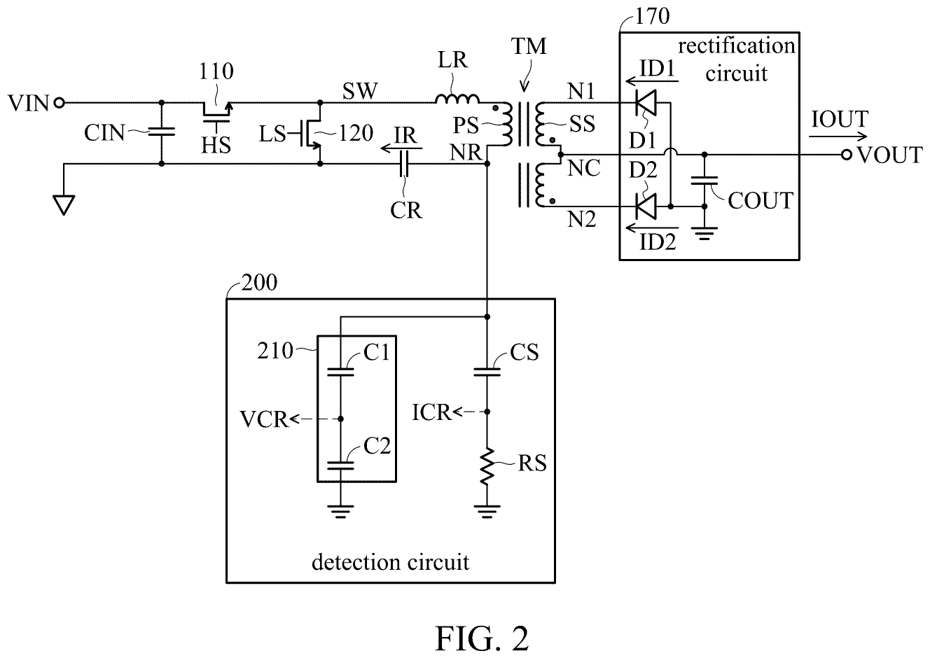

FIG. 2 is a schematic diagram showing a detection circuit in accordance with an embodiment of the present invention. The detection circuit 200 includes a detection capacitor CS, a detection resistor RS, and a capacitance voltage divider circuit 210. The detection capacitor CS is coupled to the resonant node NR, and the detection resistor RS is coupled between the detection capacitor CS and the ground. In other words, the detection capacitor CS and the detection resistor RS are connected in series to both terminals of the resonant capacitor CR. In addition, the voltage across the detection resistor RS generates a current detection signal ICR. According to some embodiments of the present invention, the current detection signal ICR is a voltage signal.

The capacitance voltage divider circuit 210 is coupled to both terminals of the resonant capacitor CR, and includes a first capacitor C1 and a second capacitor C2. The first capacitor C1 and the second capacitor C2 are configured to divide the voltage of the resonant node NR to generate a voltage detection signal VCR. According to other embodiments of the present invention, the detection resistor RS may also be connected between the resonant capacitor CR and the ground, and the detection capacitor CS is omitted, where the voltage across the detection electric RS is the current detection signal ICR.

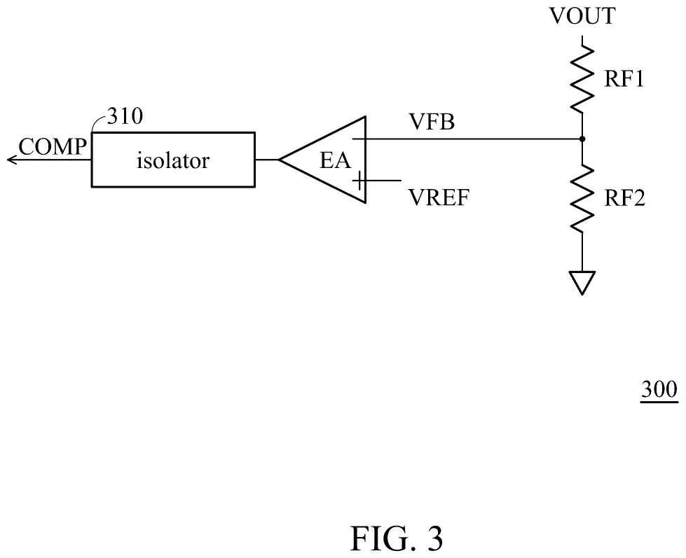

FIG. 3 is a schematic diagram showing a feedback circuit in accordance with an embodiment of the present invention. As shown in FIG. 2, the feedback circuit 300 includes a first feedback resistor RF1, a second feedback resistor RF2, an error amplifier EA, and an isolator 310. The first feedback resistor RF1 and the second feedback resistor RF2 are configured to divide the output voltage VOUT to generate the feedback voltage VFB. The negative terminal of the error amplifier EA receives the feedback voltage VFB, the positive terminal of the error amplifier EA receives the reference voltage VREF, and the output signal of the error amplifier EA generates a compensation signal COMP via the isolator 310.

According to an embodiment of the present invention, the isolator 310 may be an optocoupler. According to another embodiment of the present invention, the isolator 310 may be a transformer. According to an embodiment of the present invention, as the output voltage VOUT in FIG. 1 decreases, the compensation signal COMP increases. According to another embodiment of the present invention, as the output current IOUT in FIG. 1 increases, the output voltage VOUT decreases accordingly, causing the compensation signal COMP to rise. In other words, as the output power of the output voltage VOUT increases, the compensation signal COMP increases; as the output power of the output voltage VOUT decreases, the compensation signal COMP decreases.

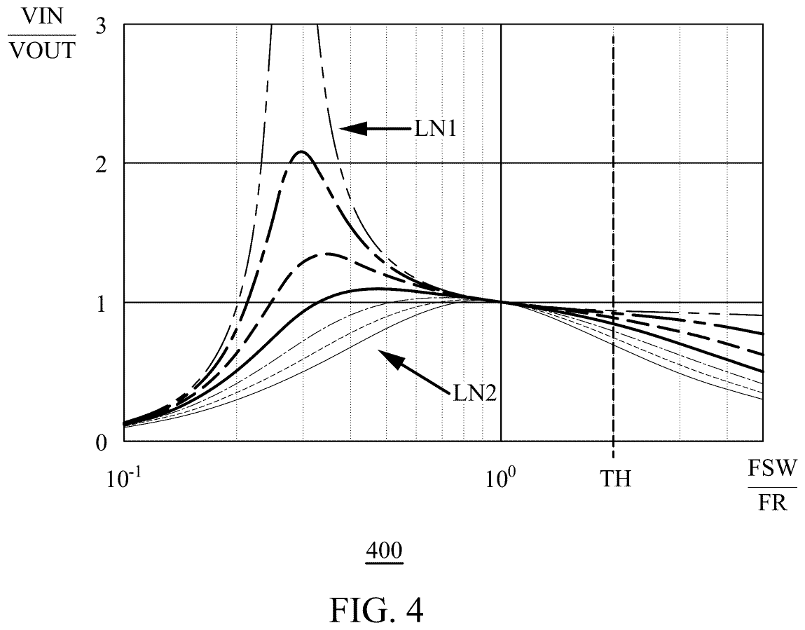

FIG. 4 is a relationship diagram showing a relationship between the voltage gain and the normalized frequency of the power conversion circuit operating in the pulse frequency modulation mode in accordance with an embodiment of the present invention. As shown in FIG. 4, the vertical axis of the relationship diagram 400 is the voltage gain, that is, a ratio of the input voltage VIN divided by the output voltage VOUT. The horizontal axis of the relationship diagram 400 is a normalized frequency, that is, the ratio of the switching frequency FSW divided by the resonant frequency FR. The switching frequency FSW is the frequency of the high-side driving signal HS and the low-side driving signal LS, and the resonant frequency FR is determined by the resonant capacitor CR and the resonant inductor LR.

As shown in FIG. 4, the first line segment LN1 represents a light load condition, and the second line segment LN2 represents a heavy load condition. Only when the switching frequency FSW is higher than the resonant frequency FR

$$( i . e . , \frac{FSW}{FR} > 1 )$$

and in the light load condition, a higher switching frequency FSW can produce a lower voltage gain. In other words, when the power conversion circuit 100 operates in the pulse frequency modulation mode and under the light load condition, the switching frequency FSW must be increased to generate a lower output voltage VOUT. However, a high switching frequency FSW may produce higher switching loss to reduce conversion efficiency. Therefore, when the normalized frequency exceeds the threshold TH, the power conversion circuit 100 switches from the pulse frequency modulation mode to the pulse width modulation mode to avoid excessive switching frequency FSW, thereby increasing conversion efficiency. As shown in the embodiment of FIG. 4, the threshold TH is greater than 1. According to other embodiments of the invention, the threshold TH may also be less than 1.

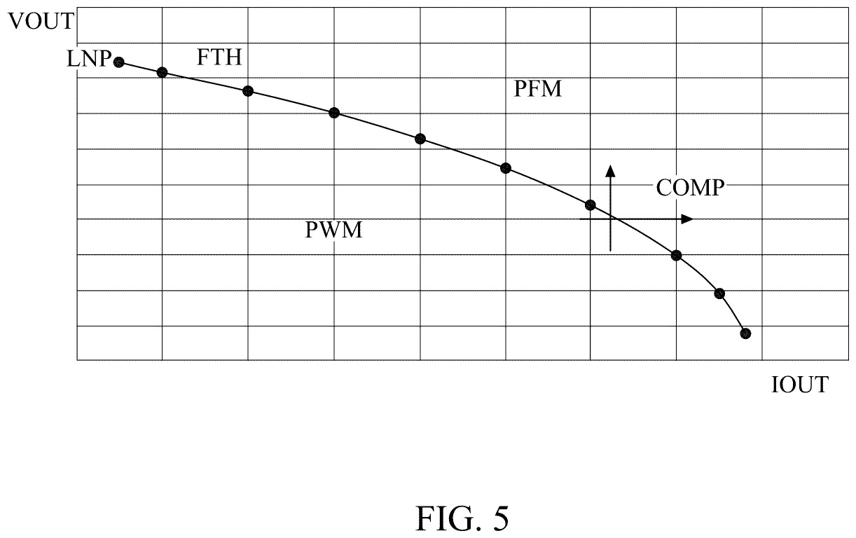

FIG. 5 is a schematic diagram showing an operating mode of the power conversion circuit in accordance with an embodiment of the present invention. As shown in the FIG. 5, the operation segment LNP is a boundary condition that the power conversion circuit 100 operates in the pulse frequency modulation mode, and the switching frequency FSW is the frequency threshold FTH. According to an embodiment of the present invention, the frequency threshold FTH is the resonant frequency FR multiplied by the threshold TH.

According to some embodiments of the present invention, when the power conversion circuit 100 needs to generate a high output voltage VOUT and/or a high output current IOUT, the power conversion circuit 100 operates in the pulse frequency modulation mode PFM, so that the power conversion circuit 100 generates the target output voltage VOUT by adjusting the switching frequency FSW. According to one embodiment of the present invention, when the power conversion circuit 100 operates in the pulse frequency modulation mode PFM and needs to generate a low output voltage VOUT and/or a low output current IOUT so that the switching frequency FSW must exceed the frequency threshold FTH, the power conversion circuit 100 switches to the pulse width modulation mode PWM. In other words, the frequency threshold FTH is the maximum switching frequency of the pulse frequency modulation mode PFM.

According to another embodiment of the present invention, when the power conversion circuit 100 operates in the pulse width modulation mode PWM and the compensation signal COMP increases, the power conversion circuit 100 switches from the pulse width modulation mode PWM to the pulse frequency modulation mode PFM. As shown in FIG. 3, as the output power of the output voltage VOUT increases, the compensation signal COMP increases. In other words, when the power conversion circuit 100 operates in the pulse width modulation mode PWM and the output power increases, the power conversion circuit 100 switches from the pulse width modulation mode PWM to the pulse frequency modulation mode PFM.

In conclusion, when the power conversion circuit 100 operates in the pulse frequency modulation mode PFM and the output power drops, the switching frequency FSW may exceed the frequency threshold FTH, so the power conversion circuit 100 operates in the pulse width modulation mode PWM to improve conversion efficiency. When the power conversion circuit 100 operates in the pulse width modulation mode PWM and the output power increases, the compensation signal COMP may exceed the voltage threshold, so the power conversion circuit 100 switches to the pulse frequency modulation mode PFM to obtain a higher conversion efficiency.

According to some embodiments of the present invention, the compensation signal COMP is a signal configured to monitor the output power of the output voltage VOUT, but not intended to be limited thereto. According to other embodiments of the present invention, it is also possible to directly monitor whether the output power exceeds a threshold to determine whether to switch from the pulse width modulation mode PWM to the pulse frequency modulation mode PFM.

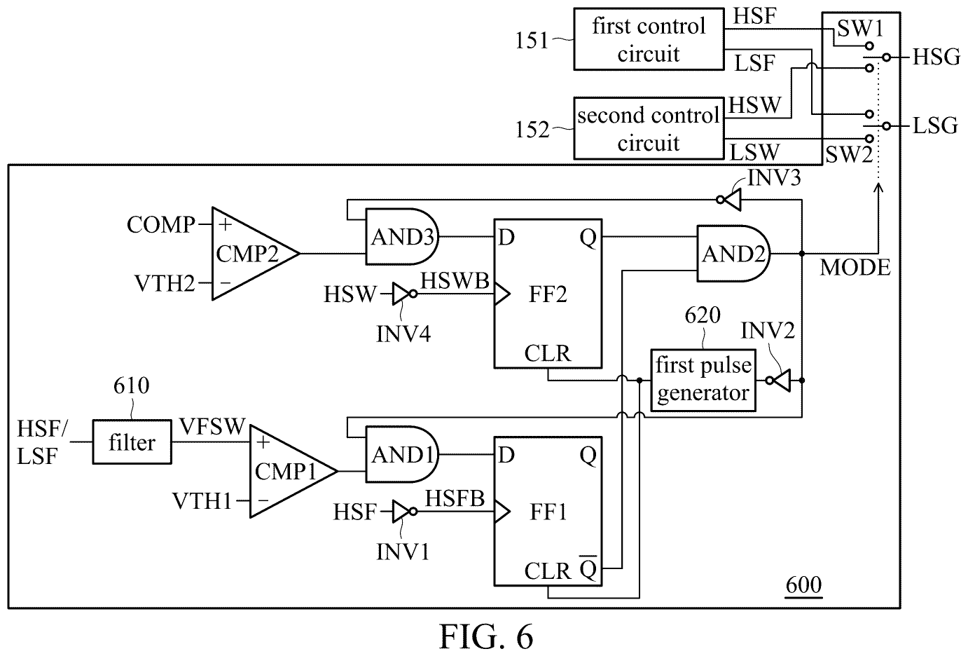

FIG. 6 is a schematic diagram showing a mode control circuit in accordance with an embodiment of the present invention. As shown in FIG. 6, the mode control circuit 600 includes a first switch SW1, a second switch SW2, a filter 610, a first comparator CMP1, a first AND gate AND1, a first inverter INV1, a first flip-flop FF1, a second AND gate AND2, a second inverter INV2, a third inverter INV3, a second comparator CMP2, a third AND gate AND3, a fourth inverter INV4, and a second flip-flop FF2.

The mode control circuit 600 controls the first switch SW1 and the second switch SW2 using the mode signal MODE to output either the high-side frequency driving signal HSF and the low-side frequency driving signal LSF generated by the first control circuit 151 or the high-side width driving signal HSW and the low-side width driving signal LSW generated by the second control circuit 152 as the high-side width driving signal HSG and the low-side gate driving signal LSG.

According to an embodiment of the present invention, when the mode signal MODE is enabled, the first switch SW1 and the second switch SW2 output the high-side frequency driving signal HSF and the low-side frequency driving signal LSF as the high-side gate driving signal HSG and the low-side gate driving signal LSG, based on the enabled mode signal MODE. The filter 610 converts the switching frequency FSW of the high-side frequency driving signal HSF or the low-side frequency driving signal LSF into a frequency voltage VFSW.

When the frequency voltage VFSW exceeds the first threshold VTH1, the first comparator CMP1 generates the enabled output signal to the first and gate AND1. According to an embodiment of the present invention, when the frequency voltage VFSW exceeds the first threshold VTH1, it means that the switching frequency FSW exceeds the frequency threshold FTH. In other words, first threshold VTH1 corresponds to the frequency threshold FTH. The first AND gate AND1 and the first flip-flop FF1 disable the mode signal MODE via the second gate AND2 based on the enabled mode signal MODE, the enabled output signal from the first comparator CMP1, and the inverted high-side frequency driving signal HSFB when the high-side transistor 110 is turned off.

According to another embodiment of the present invention, when the mode signal MODE is disabled, the first switch SW1 and the second switch SW2 output the high-side width driving signal HSW and the low-side width driving signal LSW as the high-side gate driving signal HSG and the low-side gate driving signal LSG based on the disabled mode signal MODE. The disabled mode signal MODE resets the first flip-flop FF1 and the second flip-flop FF2 via the second inverter INV2 and the first pulse generator 620.

When the compensation signal COMP exceeds the second threshold VTH2, the second comparator CMP2 provides the enabled output signal to the third AND gate AND3. The third AND gate AND3 and the second flip-flop FF2 enable mode signal MODE via the second gate AND2 based on the enabled output signal of the second comparator CMP2, the enabled output signal of the third inverter INV3, and the inverted high-side width driving signal HSWB when the high-side transistor 110 is turned off. According to some embodiments of the present invention, the mode signal MODE is enabled or disabled during the dead time when both the high-side transistor 110 and the low-side transistor 120 are turned off.

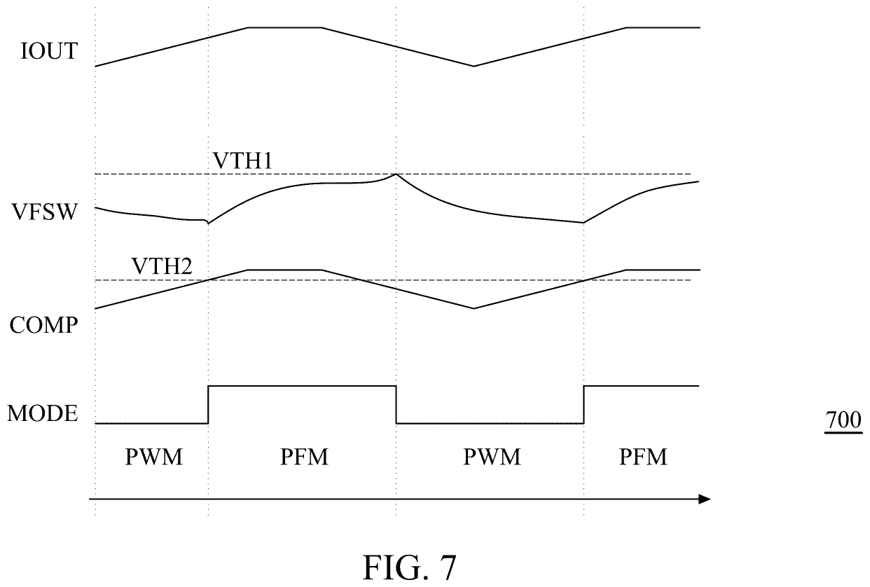

FIG. 7 shows a waveform diagram of the power conversion circuit switching between the pulse frequency modulation mode and the pulse width modulation mode in accordance with an embodiment of the present invention. The following will be explained in detail in conjunction with the power conversion circuit 100 of FIG. 1 and the control circuit 600 of FIG. 6. As shown in the waveform diagram 700 of FIG. 7, when the power conversion circuit 100 operates in the pulse frequency modulation mode PFM and the switching frequency FSW exceeds the frequency threshold FTH (that is, the frequency voltage VFSW in FIG. 6 exceeds the first threshold VTH1), the power conversion circuit 100 switches to the pulse width modulation mode PWM.

When the power conversion circuit 100 operates in the pulse width modulation mode PWM and the compensation signal COMP exceeds the second threshold VTH2, the power conversion circuit 100 switches to the pulse frequency modulation mode PFM. As shown in FIG. 7, the compensation signal COMP is related to the output current IOUT. In other words, when the output current IOUT or the output power exceeds a threshold, the power conversion circuit 100 switches from the pulse width modulation mode PWM to the pulse frequency modulation mode PFM.

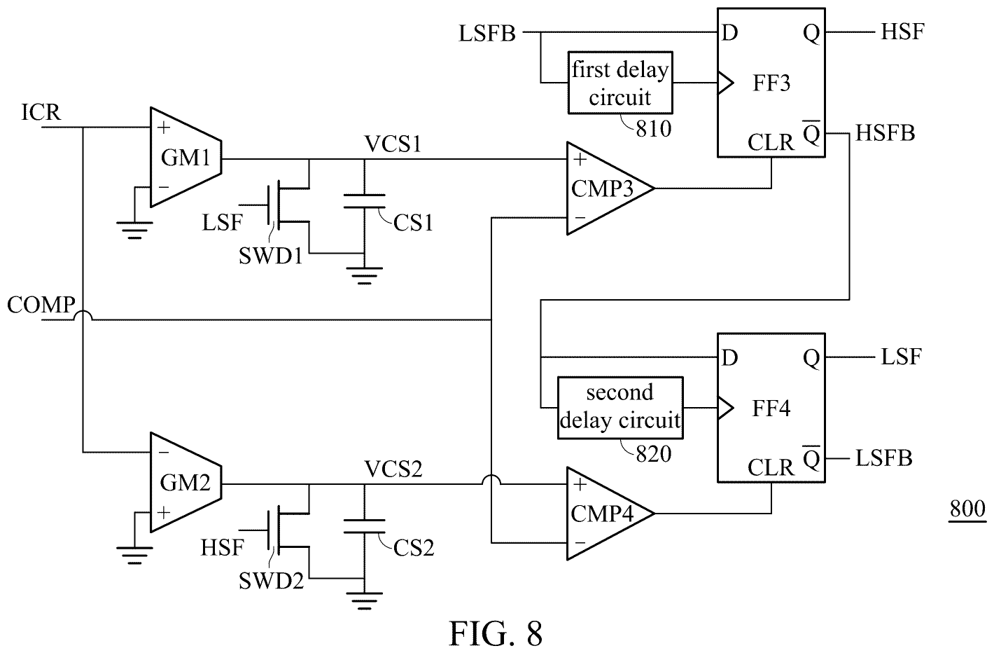

FIG. 8 is a schematic diagram showing a first control circuit in accordance with an embodiment of the present invention. As shown in FIG. 8, the first control circuit 800 includes a first delay circuit 810, a third forward and inverse FF3, a first transconductance amplifier GM1, a first discharge switch SWD1, a first detection capacitor CS1, a third comparator CMP3, a second delay circuit 820, a fourth forward and inverse FF4, a second transconductance amplifier GM2, a second discharge switch SWD2, a second detection capacitor CS2, and a fourth comparator CMP4.

When the low-side transistor 120 is turned off, the inverted low-side frequency driving signal LSFB being enabled enables the high-side frequency driving signal HSF and disables the inverted high-side frequency driving signal HSFB through the first delay circuit 810 and the third flip-flop FF3. The positive terminal of the first transconductance amplifier GM1 receives the current detection signal ICR in FIG. 2, and the negative terminal of the first transconductance amplifier GM1 is coupled to the ground.

As shown in FIG. 8, the first transconductance amplifier GM1 charges the first detection capacitor CS1 to generate the first amplified signal VCS1 based on the current detection signal ICR. When the first amplified signal VCS1 exceeds the compensation signal COMP, the third comparator CMP3 resets the third flip-flop FF3 to disable the high-side frequency driving signal HSF and turn off the high-side transistor 110. In addition, the first discharge switch SWD1 is turned on or off based on the low-side frequency driving signal LSF.

When the high-side transistor 110 is turned off, the inverted high-side frequency driving signal HSFB being enabled enables the low-side frequency driving signal LSFF and disables the inverted low-side frequency driving signal LSFB through the second delay circuit 820 and the fourth forward and reverser FF4. The positive terminal of the second transconductance amplifier GM2 is coupled to the ground, and the negative terminal of the second transconductance amplifier GM2 receives the current detection signal ICR in FIG. 2.

As shown in FIG. 8, the second transconductance amplifier GM2 charges the second detection capacitor CS2 to generate the second amplified signal VCS2 based on the current detection signal ICR. According to some embodiments of the present invention, the first amplified signal VCS1 and the second amplified signal VCS2 have different phases. When the second amplified signal VCS2 exceeds the compensation signal COMP, the fourth comparator CMP4 resets the fourth forward and reverser FF4 to disable the low-side frequency driving signal LSF and turn off the low-side transistor 120. In addition, the second discharge switch SWD2 is turned on or off based on the high-side frequency driving signal HSF.

According to some embodiments of the present invention, the first delay circuit 810 is configured to determine the dead time from the low-side transistor 120 being turned off to the high-side transistor 110 being turned on, and the second delay circuit 820 is configured to determine the dead time from the high-side transistor 110 being turned off to the low-side transistor 120 being turned on. According to some embodiments of the present invention, the on-time of the high-side transistor 110 is similar or equal to the on-time of the low-side transistor 120. According to some embodiments of the present invention, the duty cycle of the high-side transistor 110 is similar or equal to the duty cycle of the low-side transistor 120. In other words, the duty cycles of the high-side transistor 110 and the low-side transistor 120 are about 50% for each.

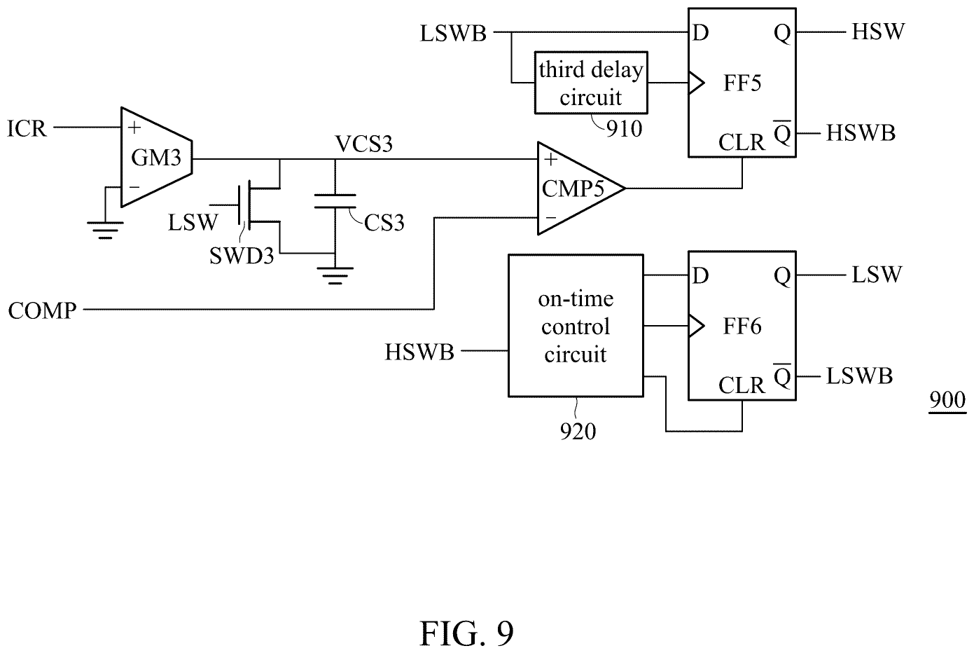

FIG. 9 is a schematic diagram showing a second control circuit in accordance with an embodiment of the present invention. As shown in FIG. 9, the second control circuit 900 includes a third delay circuit 910, a fifth flip-flop FF5, a third transconductance amplifier GM3, a third discharge switch SWD3, a third detection capacitor CS3, a fifth comparator CMP5, an on-time control circuit 920, and a sixth flip-flop FF6.

When the low-side transistor 120 is turned off, the inverted low-side width driving signal LSWB being enabled enables the high-side width driving signal HSW and disables the inverted high-side width driving signal HSWB through the third delay circuit 910 and the fifth flip-flop FF5. The positive terminal of the third transconductance amplifier GM3 receives the current detection signal ICR in FIG. 2, and the negative terminal of the third transconductance amplifier GM3 is coupled to the ground.

As shown in FIG. 9, the third transconductance amplifier GM3 charges the third detection capacitor CS3 to generate the third amplified signal VCS3 based on the current detection signal ICR. When the third amplified signal VCS3 exceeds the compensation signal COMP, the fifth comparator CMP5 resets the fifth flip-flop FF5 to disable the high-side width driving signal HSW and turn off the high-side transistor 110. In addition, the third discharge switch SWD3 is turned on or off based on the low-side width driving signal LSW.

The on-time control circuit 920 enables the low-side width driving signal LSW and disables the inverted low-side width driving signal LSWB via the sixth flip-flop FF6 based on the enabled inverted high-side width driving signal HSWB. According to some embodiments of the present invention, the on-time control circuit 920 may adjust the on-time of the low-side transistor 120 to adjust the output voltage VOUT to reach the target value. According to some embodiments of the present invention, when the low-side width driving signal LSW is enabled, the third discharge switch SWD3 is turned on to reset the third amplified signal VCS3.

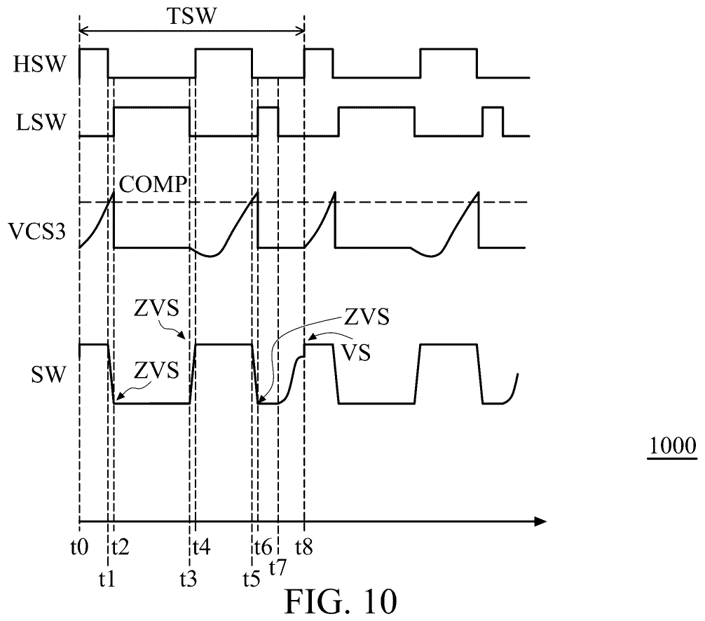

FIG. 10 shows a waveform diagram of the power conversion circuit operating in the pulse width modulation mode in accordance with an embodiment of the present invention. The following will be explained in detail in conjunction with the power conversion circuit 100 in FIG. 1 and the second control circuit 900 in FIG. 9. As shown in the waveform diagram 1000 in FIG. 10, in one switching period TSW, the high-side transistor 110 is turned on at the initial time point t0 and under the condition of valley switching (VS). Between the initial time point t0 and the first time point t1, the third amplified signal VCS3 increases continuously.

When the third amplified signal VCS3 exceeds the compensation signal COMP at the first time point t1, the high-side transistor 110 is turned off. After the dead time has elapsed, the low-side transistor 120 is turned on at the second time point t2 and under zero-voltage switching (ZVS). According to an embodiment of the present invention, the dead time between the first time point t1 and the second time point t2 is determined by the third delay circuit 910.

Between the second time point t2 and the third time point t3, the low-side transistor 120 is turned on. According to one embodiment of the present invention, the on-time of the low-side transistor 120 is a fixed value. After the dead time has elapsed, the high-side transistor 110 is turned on again at the fourth time point t4. According to an embodiment of the present invention, when the high-side transistor 110 is turned on at the fourth time point t4, zero-voltage switching is achieved.

Between the fourth time point t4 and the fifth time point t5, the third amplified signal VCS3 increases continuously, and the third amplified signal VCS3 exceeds the compensation signal COMP at the fifth time point t5 to turn off the high-side transistor 110. After the dead time has elapsed, the low-side transistor 120 is turned on at the sixth time point t6. According to one embodiment of the present invention, when the high-side transistor 110 is turned on at the sixth time point t6, zero-voltage switching is achieved. According to one embodiment of the present invention, when the current detection signal ICR drops to zero current at the seventh time point t7 (not shown in FIG. 10), the low-side transistor 120 is turned off.

Between the seventh time point t7 and the eighth time point t8, the high-side transistor 110 and the low-side transistor 120 are both turned off, and the voltage of the switch node SW rises from the low voltage level to the high voltage level. At the eighth time point t8, the high-side transistor 110 is turned on again as another switching period TSW. According to some embodiments of the present invention, the on-time control circuit 920 may adjust the length of the seventh time point t7 to the eighth time point t8 to maintain the output voltage VOUT under light load.

According to other embodiments of the present invention, the on-time control circuit 920 can adjust the length from the second time point t2 to the third time point t3 and fix the length from the seventh time point t7 to the eighth time point t8 to facilitate maintaining the output voltage VOUT under light load. According to other embodiments of the present invention, the on-time control circuit 920 may also adjust the length from the second time point t2 to the third time point t3 and the length from the seventh time point t7 to the eighth time point t8 to facilitate maintaining the output voltage VOUT under light load.

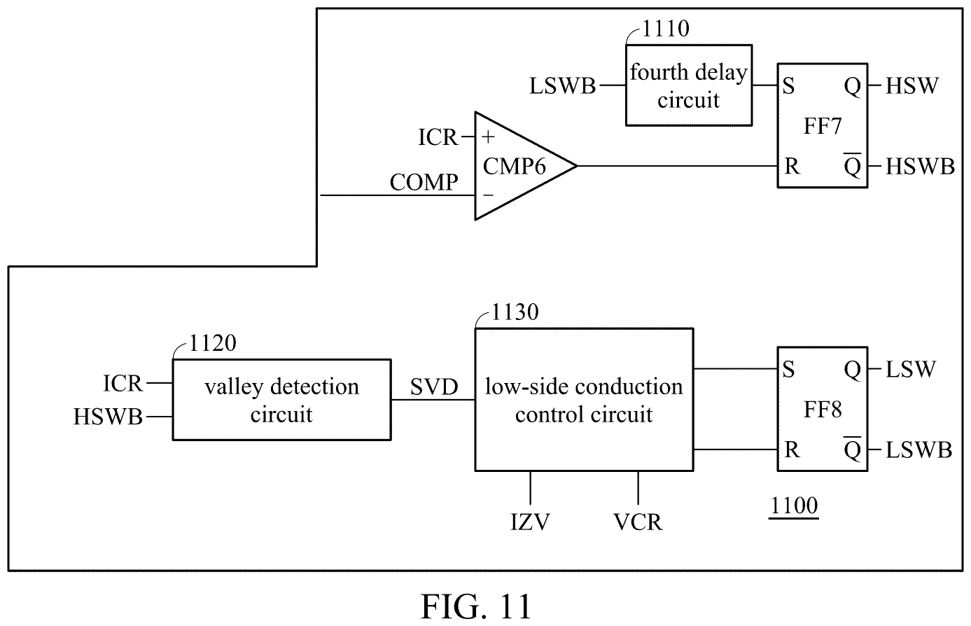

FIG. 11 is a schematic diagram showing a second control circuit in accordance with another embodiment of the present invention. As shown in FIG. 11, the second control circuit 1100 includes a fourth delay circuit 1110, a seventh flip-flop FF7, a valley detection circuit 1120, a low-side conduction control circuit 1130, an eighth flip-flop FF8, and a sixth comparator CMP6.

The seventh flip-flop FF7 enables the high-side width driving signal HSW and simultaneously disables the inverted high-side width driving signal HSWB based on the output signal generated by the fourth delay circuit 1110 delaying the inverted low-side width driving signal LSWB. According to some embodiments of the present invention, the delay time generated by the fourth delay circuit 1110 is configured to determine the dead time from the low-side transistor 120 in FIG. 1 being turned off to the high-side transistor 110 being turned on. The valley detection circuit 1120 determines that the voltage of the switch node SW is at the valley based on the state of the current detection signal ICR in response to the enabled inverted high-side width driving signal HSWB, thereby generating the valley detection signal SVD.

The low-side conduction control circuit 1130 sets or resets the eighth flip-flop FF8 based on the valley detection signal SVD, the zero-voltage current threshold IZV, and the voltage detection signal VCR, thereby generating the low-side width driving signal LSW and the inverted low-side width driving signal LSWB. According to some embodiments of the present invention, the low-side conduction control circuit 1130 can control the on-time of the low-side width driving signal LSW to be a predetermined value. According to an embodiment of the present invention, the established value may be less than the resonant period, where the resonant period is determined by the resonant capacitor CR and the resonant inductance LR of FIG. 1.

When the compensation signal COMP generated by the feedback circuit 140 of FIG. 1 does not exceed the current detection signal ICR, the sixth comparator CMP6 resets the seventh forward and reverser FF7 and disables the high-side width driving signal HSW.

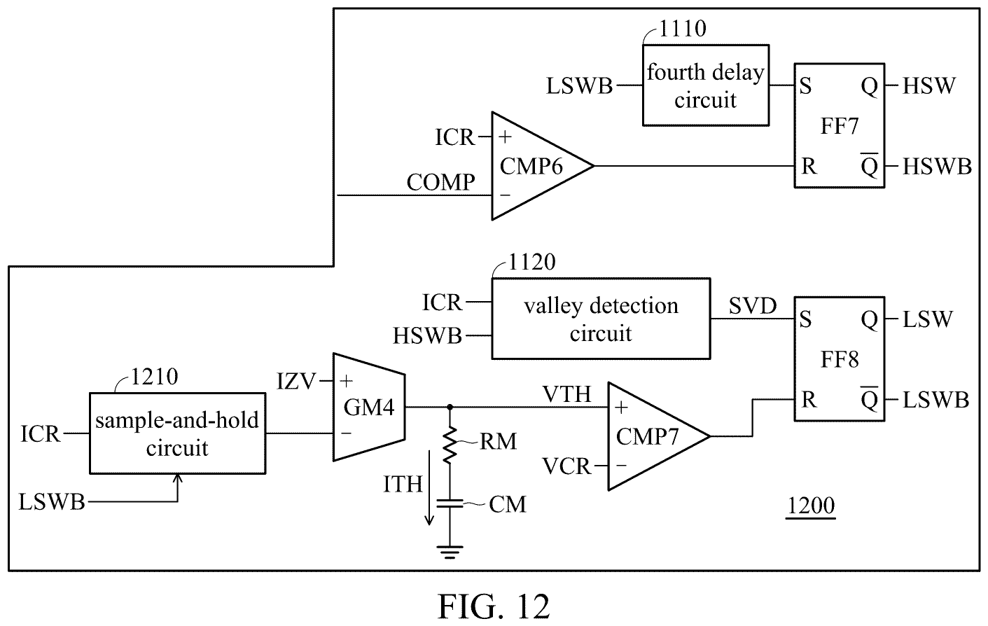

FIG. 12 is a schematic diagram showing a second control circuit in accordance with another embodiment of the present invention. Compared the second control circuit 1200 in FIG. 12 to the second control circuit in FIG. 11, the low-side conduction control circuit 1130 in FIG. 11 is replaced by the sample-and-hold circuit 1210, the fourth transconductance amplifier GM4, the transconductance resistor RM, the transconductance capacitor CM, and the seventh comparator CMP7.

The valley detection circuit 1120 generates the valley detection signal SVD based on the enabled inverted high-side width driving signal HSWB and the detection current detection signal ICR. The eighth flip-flop FF8 enables the low-side width driving signal LSW and disables the inverted low-side width driving signal LSWB based on the enabled wave valley detection signal SVD. The sample-and-hold circuit 1210 samples and holds the current detection signal ICR based on the enabled inverted low-side width driving signal LSWB.

The fourth transconductance amplifier GM4 compares the current detection signal ICR held by the sample-and-hold circuit 1210 with the zero-voltage current threshold value IZV to generate a threshold current ITH. The threshold current ITH flows through the transconductance resistor RM and the transconductance capacitor CM to generate a threshold voltage VTH. According to some embodiments of the present invention, the fourth transconductance amplifier GM4 generates different threshold currents ITH based on different differences between the current detection signal ICR and the zero-voltage current threshold value IZV.

In other words, the fourth transconductance amplifier GM4, the transconductance resistor RM, and the transconductance capacitor CM generate different threshold voltages VTH based on different differences between the current detection signal ICR and the zero-voltage current threshold value IZV. According to some embodiments of the present invention, the fourth transconductance amplifier GM4, the transconductance resistor RM, and the transconductance capacitor CM form an error amplifier.

The seventh comparator CMP7 compares the voltage detection signal VCR and the threshold voltage VTH to reset the eighth flip-flop FF8, thereby disabling the low-side width driving signal LSW and enabling the inverted low-side width driving signal LSWB.

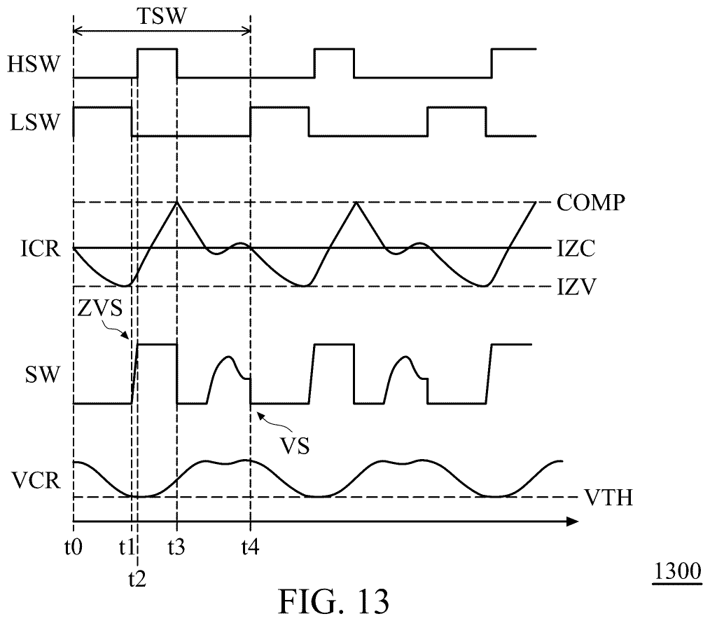

FIG. 13 shows a waveform diagram of the power conversion circuit operating in the pulse width modulation mode in accordance with another embodiment of the present invention. The following will be explained in detail in conjunction with the power conversion circuit 100 in FIG. 1 and the second control circuit 1200 in FIG. 12. As shown in the waveform diagram 1300 of FIG. 13, in one switching period TSW, the low-side width driving signal LSW is enabled at the initial time point t0. At the first time point t1, it is determined that the voltage detection signal VCR is lower than the limit voltage VTH, so as to disable the low-side width driving signal LSW.

According to some embodiments of the present invention, at the first time point t1, the current detection signal ICR reaches the zero-voltage current threshold IZV, and the voltage detection signal VCR is less than the threshold VTH generated by the fourth transconductance amplifier GM4, the transconductance resistor RM, and the transconductance capacitor CM, so that the high-side transistor 110 can be turned on under zero-voltage switching. The zero-voltage current threshold IZV is determined by the high-side parasitic capacitor COS1 of the high-side transistor 110, the low-side parasitic capacitor COS2 of the low-side transistor 120, the input voltage VIN, and the dead time TDT generated by the fourth delay circuit 1110, as shown in Eq. 1:

$$IZV = \frac{( COS 1 + COS 2 ) \times VIN}{TDT} \qquad ( Eq . 1 )$$

In other words, the resonant current IR flowing through the resonant capacitor CR must be sufficient to turn on the parasitic diode of the high-side transistor 110 so that the voltage of the switch node SW is equal to the input voltage VIN, thereby allowing the subsequent conduction of the high-side transistor 110 to achieve zero-voltage switching, so as to reduce power loss.

After the dead time generated by the fourth delay circuit 1110 in FIG. 12, the high-side width driving signal HSW is enabled at the second time point t2. According to an embodiment of the present invention, the high-side transistor 110 is turned on at the second time point t2 under zero-voltage switching, so as to reduce switching power loss. At the third time point t3, the current detection signal ICR exceeds the compensation signal COMP so that the high-side width driving signal HSW is disabled.

After the third time point t3, the voltage of the switch node SW oscillates, and the valley detection circuit 1120 determines that the voltage of the switch node SW reaches the valley (i.e., the lowest point) at the fourth time point t4, thereby enabling the low-side width driving signal LSW, so that the low-side transistor 120 achieves the valley switching.

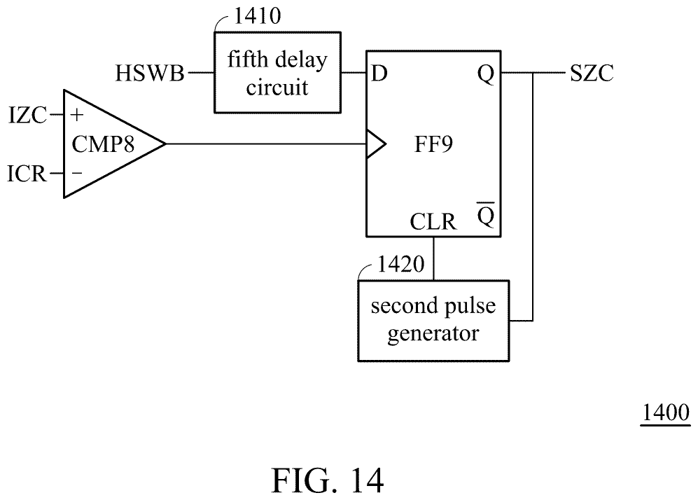

FIG. 14 is a schematic diagram showing a valley detection circuit in accordance with an embodiment of the present invention. As shown in FIG. 14, the valley detection circuit 1400 includes a fifth delay circuit 1410, an eighth comparator CMP8, a ninth flip-flop FF9, and a second pulse generator 1420. The fifth delay circuit 1410 is configured to control the delay time for providing the inverted high-side width driving signal HSWB to the ninth flip-flop FF9.

The eighth comparator CMP8 compares the current detection signal ICR and the zero-current threshold IZC to generate the clock signal of the ninth flip-flop FF9. The ninth flip-flop FF9 outputs the inverted high-side width driving signal HSWB provided by the fifth delay circuit 1410 as the zero-current detection signal SZC based on the output signal of the eighth comparator CMP8.

According to some embodiments of the present invention, when the current detection signal ICR drops to the zero-current threshold IZC, the eighth comparator CMP8 outputs a positive pulse, so that the ninth flip-flop FF9 outputs the inverted high-side width driving signal HSWB as the zero-current detection signal SZC in response to the positive pulse output by the eighth comparator CMP8. According to some embodiments of the invention, the zero-current threshold IZC may be zero or slightly greater than zero. According to other embodiments of the present invention, the zero-current threshold IZC may also be slightly less than zero. In other words, the zero-current threshold IZC is a value close to zero.

When the inverted high-side width driving signal HSWB is enabled, the zero-current detection signal SZC output by the valley detection circuit 1400 is also enabled. The second pulse generator 1420 resets the ninth flip-flop FF9 based on the enabled zero-current detection signal SZC. According to some embodiments of the present invention, the valley detection circuit 1400 corresponds to the valley detection circuit 1120 in FIG. 12, which is configured to detect that the current detection signal ICR drops to the zero-current threshold IZC.

Since the zero-current threshold IZC is a value close to zero, when the resonant current IR corresponding to the current detection signal ICR drops to zero, it indicates that the voltage of the switch node SW at this time is the minimum value. In other words, the current detection signal ICR dropping to the zero-current threshold IZC is equivalent to the voltage of the switch node SW reaching the valley. According to some embodiments of the present invention, the valley detection circuit 1400 corresponds to the valley detection circuit 1120 in FIG. 12, and the valley detection signal SVD in FIG. 12 corresponds to the valley detection signal SZC in FIG. 14.

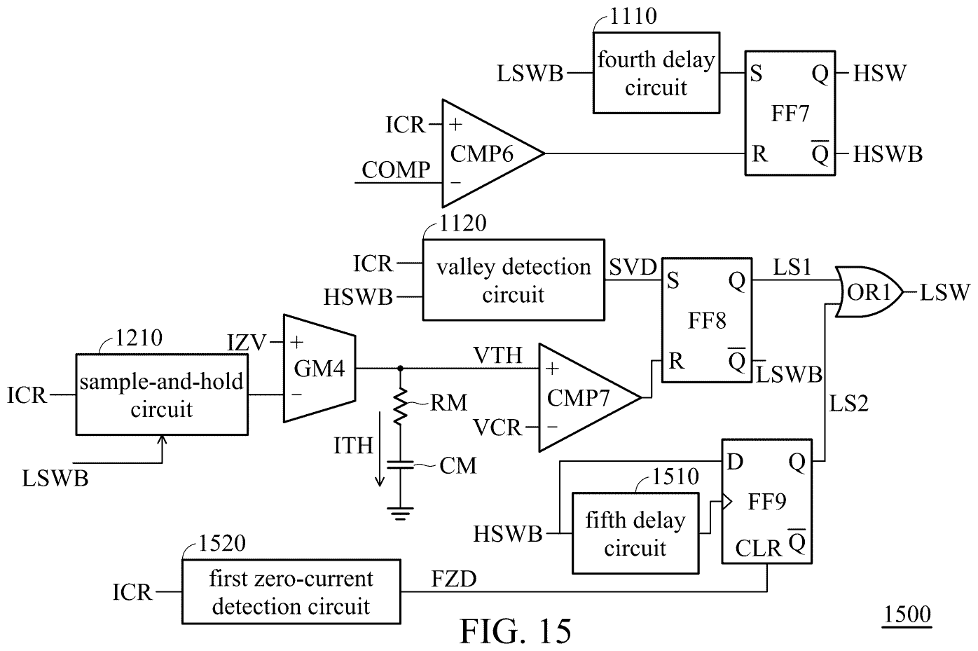

FIG. 15 is a schematic diagram showing a second control circuit in accordance with another embodiment of the present invention. Compared the second control circuit 1500 in FIG. 15 to the second control circuit 1200, the eighth flip-flop FF8 of the second control circuit 1500 outputs the first low-side width driving signal LS1, and the second control circuit 1500 further includes a fifth delay circuit 1510, a ninth flip-flop FF9, a first zero-current detection circuit 1520, and a first OR gate OR1.

As shown in FIG. 15, the fifth delay circuit 1510 delays the inverted high-side width driving signal HSWB by a delay time as the clock signal of the ninth flip-flop FF9. The ninth flip-flop FF9 outputs the inverted high-side width driving signal HSWB as the second low-side width driving signal LS2 based on the delayed inverted high-side width driving signal HSWB.

The first zero-current detection circuit 1520 is configured to detect that the current detection signal ICR drops to zero, thereby resetting the ninth flip-flop FF9 and disabling the second low-side width driving signal LS2. According to some embodiments of the present invention, the first zero-current detection circuit 1520 can be implemented using the valley detection circuit 1400. The first OR gate OR1 performs a logical OR operation on the first low-side width driving signal LS1 and the second low-side width driving signal LS2 to generate the low-side width driving signal LSW.

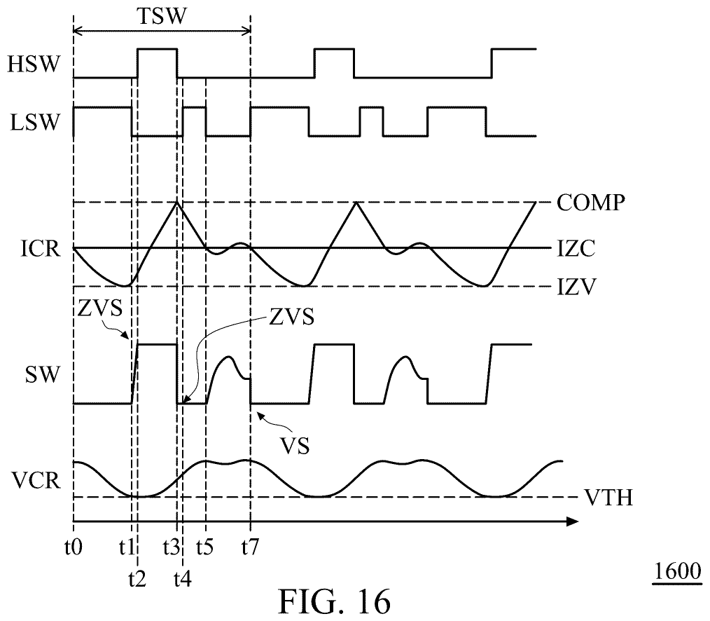

FIG. 16 is a waveform diagram showing a power conversion circuit operating in a pulse width modulation mode in accordance with another embodiment of the present invention. The following will be explained in detail in conjunction with the power conversion circuit 100 in FIG. 1 and the second control circuit 1500 of FIG. 15 to facilitate a detailed description. As shown in the waveform diagram 1600 of FIG. 16, the initial time point t0 to the third time point t3 are the same as the waveform diagram 1300 of FIG. 13, which will not be repeated herein.

After the high-side width driving signal HSW is turned off at the third time point t3, the fifth delay circuit 1510 delays the output signal of the inverted high-side width driving signal HSWB as the clock signal of the ninth flip-flop FF9, so that the low-side width driving signal LSW is enabled again at the fourth time point t4, thereby turning on the low-side transistor 120. According to some embodiments of the present invention, the dead time from the third time point t3 to the fourth time point t4 is determined by the delay time of the fifth delay circuit 1510. According to some embodiments of the present invention, the dead time from the third time point t3 to the fourth time point t4 is sufficient to enable the low-side transistor 120 to achieve zero-voltage switching.

When the first zero-current detection circuit 1520 determines that the current detection signal ICR drops to zero at the fifth time point t5, the first zero-current detection circuit 1520 generates a falling zero-current signal FZD to reset the ninth flip-flop FF9, thereby disabling the low-side width driving signal LSW. At the seventh time point t7, the valley detection circuit 1120 determines that the voltage of the switch node SW reaches the valley (i.e., the lowest point), and enables the low-side width driving signal LSW, so that the low-side transistor 120 achieves valley switching.

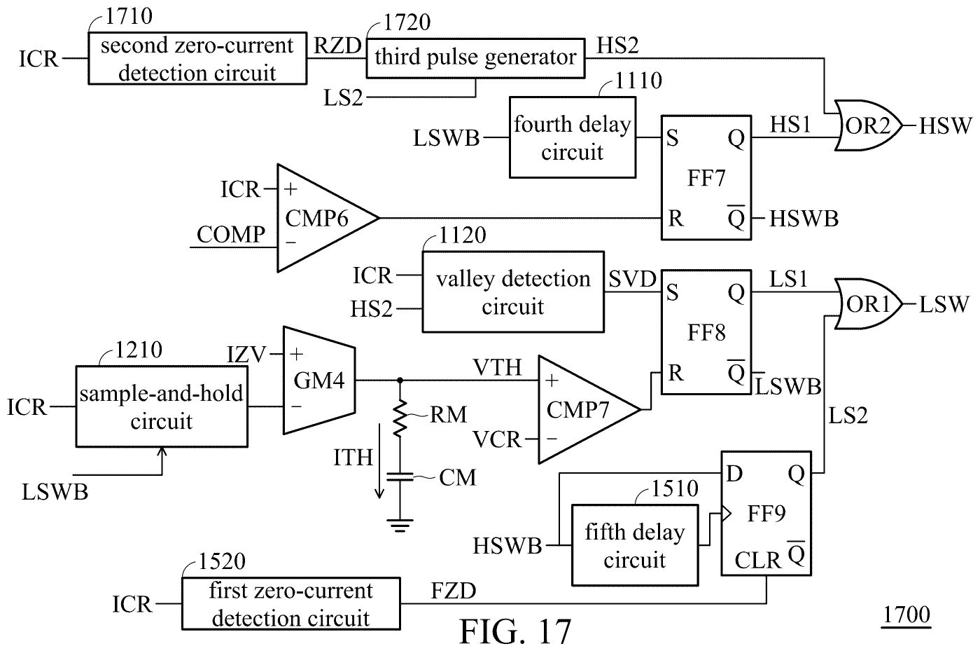

FIG. 17 is a schematic diagram of a second control circuit in accordance with another embodiment of the present invention. Compared the second control circuit 1700 of FIG. 17 with the second control circuit 1500, the seventh flip-flop FF7 of the second control circuit 1700 outputs the first high-side width driving signal HS1, and the second control circuit 1700 further includes a second zero-current detection circuit 1710, a third pulse generator 1720, and a second OR gate OR2.

The second zero-current detection circuit 1710 is configured to detect that the current detection signal ICR rises to zero to generate a rising zero-current signal RZD. The third pulse generator 1720 is enabled by the second low-side width driving signal LS2, and generates the second high-side width driving signal HS2 based on the rising zero-current signal RZD. According to some embodiments of the present invention, the enable period of the second high-side width driving signal HS2 is determined by the pulse width generated by the third pulse generator 1720. The second OR gate OR2 performs a logical OR operation on the first high-side width driving signal HS1 and the second high-side width driving signal HS2 to generate the high-side width driving signal HSW.

In addition, compared with the second control circuit 1500, the valley detection circuit 1120 of the second control circuit 1700 generates the valley detection signal SVD based on the second high-side width driving signal HS2 and the current detection signal ICR. As shown in FIG. 14, the valley detection circuit 1120 of the second control circuit 1700 can be implemented by replacing the inverted high-side width driving signal HSWB received by the valley detection circuit 1400 with the second high-side width driving signal HS2.

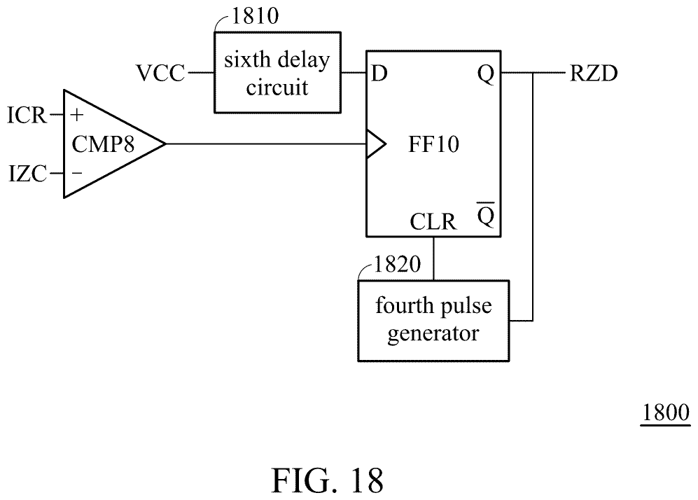

FIG. 18 is a schematic diagram showing a second zero-current detection circuit in accordance with an embodiment of the present invention. As shown in FIG. 18, the second zero-current detection circuit 1800 includes a sixth delay circuit 1810, an eighth comparator CMP8, a tenth flip-flop FF10, and a fourth pulse generator 1820. The sixth delay circuit 1810 is configured to control the delay time of providing the supply voltage VCC to the tenth flip-flop FF10. When the current detection signal ICR increases to the zero-current threshold value IZC, the eighth comparator CMP8 outputs a positive pulse.

The tenth flip-flop FF10 outputs the supply voltage VCC as a rising zero-current signal RZD based on the rising edge generated by the eighth comparator CMP8. The fourth pulse generator 1820 resets the tenth flip-flop FF10 based on the rising zero-current signal RZD. In other words, when the current detection signal ICR increases to the zero-current threshold value IZC, the second zero-current detection circuit 1800 generates a positive pulse in the rising zero-current signal RZD.

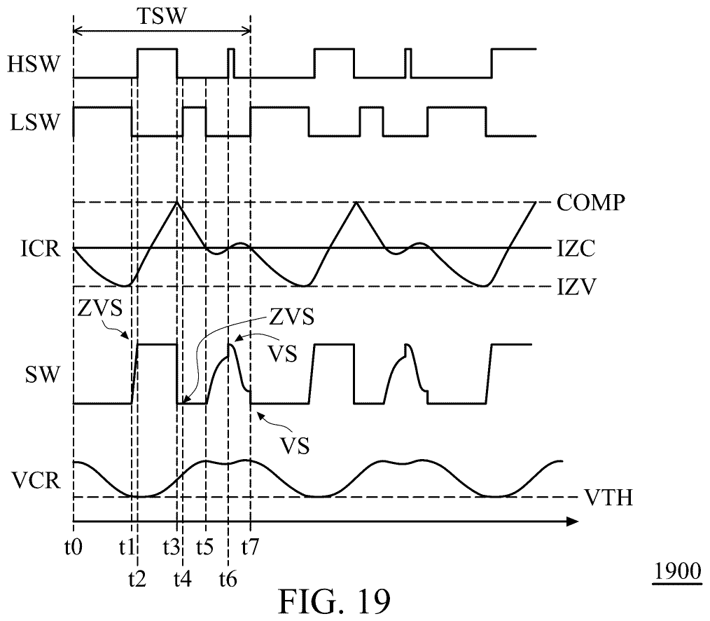

FIG. 19 is a waveform diagram of the power conversion circuit operating in the pulse width modulation mode in accordance with another embodiment of the present invention. The following will be explained in detail in conjunction with the power conversion circuit 100 in FIG. 1 and the second control circuit 1700 of FIG. 17 to facilitate a detailed description. As shown in the waveform diagram 1900 of FIG. 19, the initial time point t0 to the fifth time point t5 are the same as those of FIG. 16, but not intended to be repeated herein.

At the sixth time point t6, the second zero-current detection circuit 1710 detects the current detection signal ICR increasing to the zero-current threshold value IZC to enable the high-side width drive signal HSW, so that the voltage of the switch node SW rises to the input voltage VIN. According to some embodiments of the present invention, the second zero-current detection circuit 1710 is a valley detection circuit for detecting that the voltage across the high-side transistor 110 is at a valley voltage, and the valley detection circuit 1120 is configured to detect the voltage across the low-side transistor 120 being at a valley voltage to generate a valley detection signal SVD.

In addition, a higher voltage of the switch node SW helps to generate a lower valley voltage of the switch node SW. Therefore, when the low-side transistor 120 is turned on at the seventh time point t7, the valley voltage of the switch node SW is less than the valley voltage of the switch node SW at the seventh time point t7 of FIG. 16. In other words, turning on the high-side transistor 110 again at the sixth time point t6 helps to increase the conversion efficiency of the power conversion circuit 100. According to some embodiments of the present invention, when the voltage across the high-side transistor 110 or the low-side transistor 120 is not equal to zero, it means that there is still charge stored in the parasitic capacitance of the high-side transistor 110 or the low-side transistor 120. At this time, turning on the high-side transistor 110 or the low-side transistor 120 requires discharging the charge stored in the parasitic capacitance and converting it into heat. Therefore, zero-voltage switching improves conversion efficiency more than valley switching.

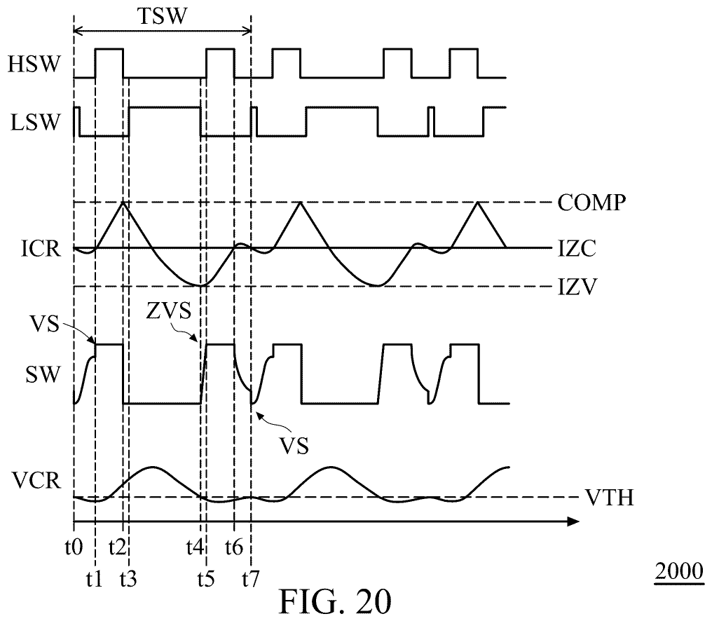

FIG. 20 is a waveform diagram of the power conversion circuit operating in the pulse width modulation mode in accordance with another embodiment of the present invention. The following will be explained in detail in conjunction with the power conversion circuit 100 in FIG. 1 and the second control circuit 1700 of FIG. 17 to facilitate a detailed description.

As shown in the waveform diagram 1200 of FIG. 20, the low-side transistor 120 is turned on under valley switching at the initial time point t0. Between the initial time point t0 and the first time point t1, the voltage of the switch node SW rises, and the high-side transistor 110 is turned on under valley switching at the first time point t1. At the second time point t2, the current detection signal ICR exceeds the compensation signal COMP, so that the high-side transistor 110 is turned off. Then, the low-side transistor 120 is turned on at the third time point t3, where the second time point t2 to the third time point t3 is a dead time determined by the fifth delay circuit 1410 of FIG. 14.

When the current detection signal ICR reaches the zero-voltage current threshold IZV, the low-side transistor 120 is turned off, so that the high-side transistor 110 is turned on under zero-voltage switching at the fifth time point t5. In other words, when the resonant current IR is sufficient (i.e., the resonant current IR flowing from the resonant node NR to the switch node SW is sufficient to turn on the parasitic diode of the high-side transistor 110 so as to pull the voltage of the switch node SW to the input voltage VIN), the low-side transistor 120 can be turned off.

When the current detection signal ICR increases to the zero-current threshold value IZC at the sixth time point t6, the high-side transistor 110 is turned off. Then, the low-side transistor is turned on again at the seventh time point t7. According to some embodiments of the present invention, since both the high-side transistor 110 and the low-side transistor 120 are turned on under valley switching or zero-voltage switching, the conversion efficiency of the power conversion circuit 100 is improved.

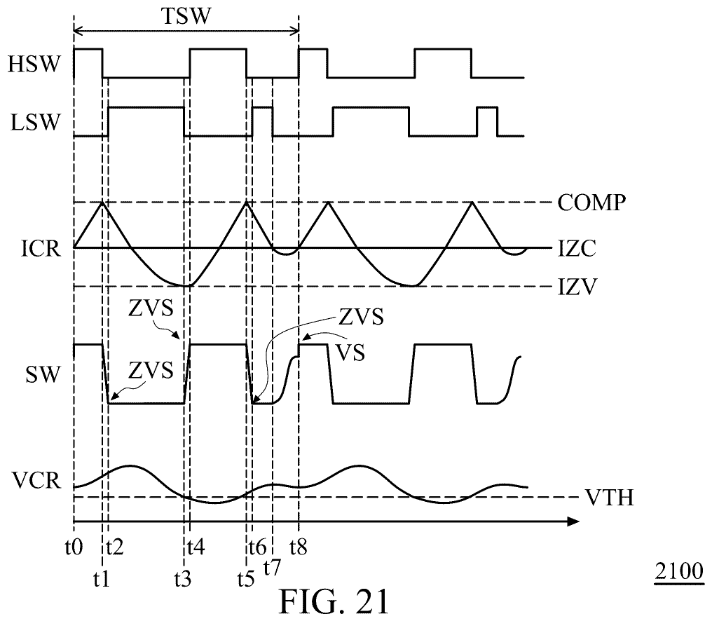

FIG. 21 is a waveform diagram of the power conversion circuit operating in the pulse width modulation mode in accordance with another embodiment of the present invention. The following will be explained in detail in conjunction with the power conversion circuit 100 in FIG. 1 and the second control circuit 1700 of FIG. 17 to facilitate a detailed description.

As shown in the waveform diagram 2100 of FIG. 21, the high-side transistor 110 is turned on under valley switching at the initial time point t0, and the current detection signal ICR increases continuously from the initial time point t0 and the first time point t1. When the current detection signal ICR exceeds the compensation signal COMP at the first time point t1, the high-side transistor 110 is turned off. After the dead time, the low-side transistor 120 is turned on at the second time point t2. When the current detection signal ICR reaches the zero-voltage current threshold IZV at the third time point t3, the low-side transistor 120 is turned off, so that the high-side transistor 110 is turned on under zero-voltage switching at the fourth time point t4.

Then, when the current detection signal ICR exceeds the compensation signal COMP at the fifth time point t5, the high-side transistor 110 is turned off. After the dead time, the low-side transistor 120 is turned on at the sixth time point t6. When the current detection signal ICR drops to the zero-current threshold value IZC, the low-side transistor 120 is turned off at the seventh time point t7. Between the seventh time point t7 and the eighth time point t8, the high-side transistor 110 and the low-side transistor 120 are both turned off, and the voltage of the switch node SW rises. Finally, the high-side transistor 110 is turned on again at the eighth time point t8.

Compared to the waveform 1900 of FIG. 19 having two times of valley switching among four times of turning on transistors, the waveform diagram 2100 reduces the number of times of valley switching to one, which helps to ensure that the power loss is kept at a low level. Since the high-side transistor 110 and the low-side transistor 120 are both turned on under zero-voltage switching or valley switching, and the resonant current IR flowing through the resonant capacitor CR is zero during valley switching, the conversion efficiency of the power conversion circuit 100 is improved.

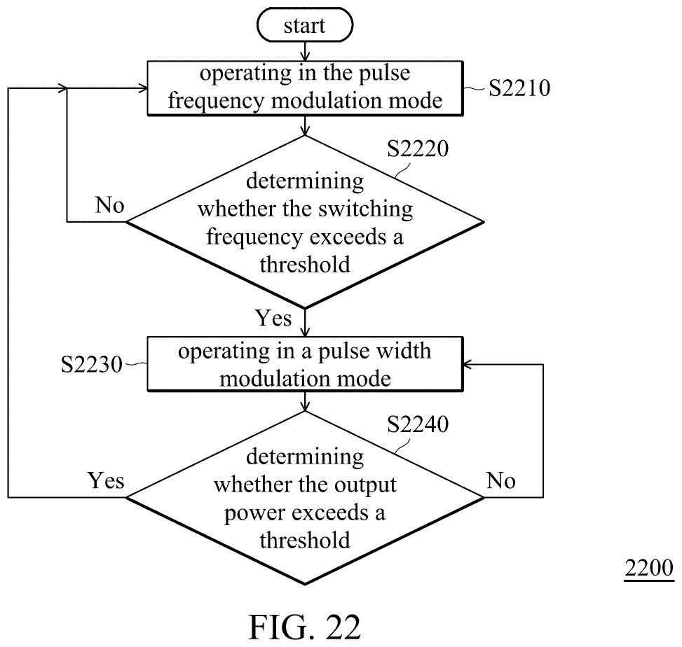

FIG. 22 is a flowchart showing a control method in accordance with an embodiment of the present invention. The following description of the control method 2200 will be combined with the power conversion circuit 100 of FIG. 1 for detailed description.

First, the power conversion circuit 100 operates in the pulse frequency modulation mode PFM (Step S2210). Next, it is determined whether the switching frequency FSW of the high-side drive signal HS and the low-side drive signal LS exceeds the threshold (Step S2220). As shown in the embodiment of FIG. 4, it is determined whether the switching frequency FSW exceeds the product of the resonant frequency FR and the threshold TH. As shown in the embodiment of FIG. 5, it is determined whether the switching frequency FSW exceeds the frequency threshold FTH.

When Step S2220 determines that the switching frequency FSW exceeds the threshold, the power conversion circuit 100 switches to the pulse width modulation mode PWM (Step S2230). When Step S2220 determines that the switching frequency FSW does not exceed the threshold, it returns to Step S2210 to continue to operate in the pulse frequency modulation mode PFM. After Step S2230, it is determined whether the output power of the output voltage VOUT exceeds the threshold (Step S2240). When it is determined that the output power does not exceed the threshold, it returns to Step S2230 to continue to operate in the pulse width modulation mode PWM. When it is determined that the output power exceeds the threshold, it returns to Step S2210, and the power conversion circuit 100 switches to the pulse frequency modulation mode PFM.

According to other embodiments of the present invention, the control method 2200 may also start from Step S2230. It is illustrated that the control method 2200 first executes Step S2210 and then executes Step S2230 for explanation herein, but not intended to be limited thereto.

The present invention proposes a power conversion circuit and a control method thereof that switch between a pulse frequency modulation mode and a pulse width modulation mode, so as to achieve the requirements of a wide range of output voltages, high output power, and high conversion efficiency at the same time. Since the power conversion circuit operating in the pulse frequency modulation mode is beneficial to provide better conversion efficiency under high output power conditions, and the power conversion circuit operating in the pulse width modulation mode is beneficial to provide better conversion efficiency under low output power conditions, operating the power conversion circuit in the corresponding mode under different output power conditions is beneficial to improve the overall conversion efficiency of the wide range of output voltages.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit, comprising:
a transformer, comprising a primary coil and a secondary coil;
a resonant capacitor;
a resonant inductor, wherein the primary coil, the resonant capacitor, and the resonant inductor are coupled in series between a switch node and a ground;
a high-side transistor, providing an input voltage to the switch node based on a high-side driving signal;
a low-side transistor, coupling the switch node to the ground based on a low-side driving signal; and
a control circuit, operating in a pulse frequency modulation mode to generate the high-side driving signal and the low-side driving signal with a switching frequency;
wherein when the switching frequency exceeds a first threshold, the control circuit switches from the pulse frequency modulation mode to a pulse width modulation mode.

2. The power conversion circuit as claimed in claim 1, wherein the resonant capacitor and the resonant inductor determine a resonant frequency;
wherein the first threshold exceeds the resonant frequency.

3. The power conversion circuit as claimed in claim 1, wherein the resonant inductor is generated by a leakage inductance of the primary coil.

4. The power conversion circuit as claimed in claim 1, wherein when the control circuit operates in the pulse frequency modulation mode, the switch frequency is related to the output voltage;
wherein when the control circuit operates in the pulse width modulation mode, an on-time of the low-side transistor is related to the output voltage.

5. The power conversion circuit as claimed in claim 1, wherein when the control circuit operates in the pulse width modulation mode and an output power exceeds a second threshold, the control circuit switches to the pulse frequency modulation mode.

6. The power conversion circuit as claimed in claim 5, further comprising:
a rectification circuit, converting energy of the secondary coil to the output power of an output voltage;
a detection circuit, coupled to the resonant node to generate a current detection signal; and
a feedback circuit, generating a compensation signal based on a difference between the output voltage and a reference voltage.

7. The power conversion circuit as claimed in claim 6, wherein the control circuit generates the high-side driving signal and the low-side driving signal based on the current detection signal and the output power of the output voltage;
wherein the compensation signal is related to the output power;
wherein when the compensation signal exceeds a third threshold, the control circuit operates in the pulse frequency modulation mode.

8. The power conversion circuit as claimed in claim 7, wherein the control circuit further comprises:
a mode control circuit, configured to determine a mode signal based on the switch frequency and the compensation signal;
wherein the control circuit operates in either the pulse frequency modulation mode or the pulse width modulation mode based on the mode signal.

9. The power conversion circuit as claimed in claim 8, wherein the mode control circuit further comprises:
a first comparator, comparing the compensation signal with the third threshold to generate a first comparison signal; and
a second comparator, comparing the switching frequency with the first threshold to generate a second comparison signal;
wherein when the compensation signal exceeds the third threshold, the first comparator enables the first comparison signal;
wherein when the switching frequency exceeds the first threshold, the second comparator enables the second comparison signal.

10. The power conversion circuit as claimed in claim 9, wherein the mode control circuit enables the mode signal based on the first comparison signal being enabled;
wherein the mode control circuit disables the mode signal based on the second comparison signal being enabled;
wherein when the mode signal is enabled, the control circuit operates in the pulse frequency modulation mode;
wherein when the mode signal is disabled, the control circuit operates in the pulse width modulation mode.

11. The power conversion circuit as claimed in claim 10, wherein the mode signal is enabled or disabled during both the high-side transistor and the low-side transistor being turned off.

12. The power conversion circuit as claimed in claim 6, wherein the control circuit further comprises:
a first control circuit, generating the high-side driving signal and the low-side driving signal based on the current detection signal and the compensation signal;
wherein when the control circuit operates in the pulse frequency modulation mode, the control circuit drives the high-side transistor and the low-side transistor using the high-side driving signal and the low-side driving signal generated by the first control circuit respectively.

13. The power conversion circuit as claimed in claim 12, wherein the first control circuit further comprises:
a first transconductance amplifier, generating a first amplified signal based on the current detection signal;
a second transconductance amplifier, generating a second amplified signal based on the current detection signal, wherein the first amplified signal and the second amplified signal have different phases;
a third comparator, wherein when the first amplified signal exceeds the compensation signal, the third comparator enables a third comparison signal; and
a fourth comparator, wherein when the second amplified signal exceeds the compensation signal, the fourth comparator enables a fourth comparison signal;
wherein the first control circuit disables the high-side driving signal based on the third comparison being enabled and enables the low-side driving signal after a first dead time;
wherein the first control circuit disables the low-side driving signal based on the fourth comparison signal being enabled and enables the high-side driving signal after a second dead time.

14. The power conversion circuit as claimed in claim 6, wherein the control circuit further comprises:
a second control circuit, generating the high-side driving signal and the low- side driving signal based on the current detection signal and the compensation signal;
wherein when the control circuit operates in the pulse width modulation mode, the control circuit drives the high-side transistor and the low-side transistor using the high-side driving signal and the low-side driving signal from the second control circuit, respectively.

15. The power conversion circuit as claimed in claim 14, wherein the second control circuit further comprises:
a third transconductance amplifier, generating a third amplified signal based on the current detection signal;
a fifth comparator, wherein when the third amplified signal exceeds the compensation signal, the fifth comparator enables a fifth comparison signal; and
an on-time control circuit, adjusting an on-time of the low-side driving signal;
wherein the second control circuit disables the high-side driving signal based on the fifth comparison signal being enabled;
wherein the on-time control circuit enables the low-side driving signal after the high-side driving signal is disabled and a third dead time has been delayed;
wherein the second control circuit enables the high-side driving signal after the low-side driving signal is disabled and a fourth dead time has been delayed.

16. A control method for controlling a power conversion circuit, wherein the control method comprises:
operating in a pulse frequency modulation mode to drive a first transistor and a second transistor on a primary side of the power conversion circuit with a switching frequency and to generate an output voltage on a secondary side of the power conversion circuit;
determining whether the switching frequency exceeds a first threshold;
when the switching frequency does not exceed the first threshold, operating in the pulse frequency modulation mode; and
when the switching frequency exceeds the first threshold, switching from the pulse frequency modulation mode to a pulse width modulation mode.

17. The control method as claimed in claim 16, wherein the primary side comprises a resonant capacitor and a resonant inductor coupled in series;
wherein the resonant capacitor and the resonant inductor determine a resonant frequency;
wherein the first threshold exceeds the resonant frequency.

18. The control method as claimed in claim 16, wherein in the pulse frequency modulation mode, the output voltage is related to the switching frequency.

19. The control method as claimed in claim 16, further comprising:
detecting output power of the output voltage;
when operating in the pulse width modulation mode, determining whether the output power exceeds a second threshold;
when the output power does not exceed the second threshold, operating in the pulse width modulation mode; and
when the output power exceeds the second threshold, switching the pulse width modulation mode to the pulse frequency modulation mode.

20. The control method as claimed in claim 16, wherein when operating in the pulse frequency modulation mode, an on-time of the high-side transistor is equal to an on-time of the low-side transistor.

21. The control method as claimed in claim 16, wherein when operating in the pulse width modulation mode, each switching period comprises a plurality of periods:
turning on the first transistor and turning off the second transistor in a first driving period;
after the first driving period, simultaneously turning off the first transistor and the second transistor in a first reset period;
after the first rest period, turning off the first transistor and turning on the second transistor in a second driving period;
after the second driving period, simultaneously turning off the first transistor and the second transistor in a second rest period;
after the second rest period, turning on the first transistor and turning off the second transistor in a third driving period;
after the third driving period, simultaneously turning off the first transistor and the second transistor in a third rest period;
after the third rest period, turning off the first transistor and turning on the second transistor in a fourth driving period; and
after the fourth driving period, simultaneously turning off the first transistor and the second transistor in a fourth rest period.

22. The control method as claimed in claim 21, further comprising:
after the fourth rest period of a first switching period, beginning the first driving period of a second switching period;
wherein when the first transistor is turned on during the first driving period of the second switching period, the first transistor is turned on under valley switching.

23. The control method as claimed in claim 21, wherein a length of the first driving period is related to an output voltage of the power conversion circuit.

24. The control method as claimed in claim 21, further comprising:
adjusting a length of the first rest period to reduce a voltage across the second transistor when the second transistor is turned on during the second driving period.

25. The control method as claimed in claim 21, wherein a length of the second driving period is related to whether the first transistor achieves zero-voltage switching during the third driving period.

26. The control method as claimed in claim 25, further comprising:
adjusting a length of the second driving period and a length of the second rest period to reduce a voltage across the first transistor when the first transistor is turned on during the third driving period.

27. The control method as claimed in claim 21, wherein a length of the third driving period is related to the output voltage.

28. The control method as claimed in claim 21, further comprising:
adjusting a length of the third rest period to reduce a voltage across the second transistor when the second transistor is turned on during the fourth driving period.

29. The control method as claimed in claim 21, wherein the first transistor achieves zero-voltage switching when the first transistor is turned on during the third driving period;
wherein the first transistor achieves valley switching when the first transistor is turned on during the first driving period.

30. The control method as claimed in claim 21, wherein the second transistor achieves zero-voltage switching during the second driving period and the fourth driving period.
